(19) United States
(12) Patent Application Publication
(10) Pub. No.: US 2026/0046864 A1
(43) Pub. Date: Feb. 12, 2026

(54) USER EQUIPMENT, BASE STATION AND METHOD FOR CONFIGURED GRANT UPLINK TRANSMISSION

(71) Applicant: LENOVO (BEIJING) LIMITED, Beijing (CN)

(72) Inventors: Yu Zhang, Beijing (CN); Haipeng Lei, Beijing (CN)

(21) Appl. No.: 19/102,900

(22) PCT Filed: Aug. 12, 2022
(86) PCT No.: PCT/CN2022/112076

§ 371 Date: Feb. 11, 2025

(51) Int. Cl. H04W 72/1268; H04L 5/14

(52) U.S. Cl. CPC H04W 72/1268; H04L 5/14

(57) ABSTRACT

The present application relates to a UE, a BS and a method for CG UE transmission. The method includes: receive, via the UE, a CG configuration from the BS: determine, via the UE, whether to perform a CG-PUSCH transmission in a first set of symbols corresponding to the CG configuration, wherein the first set of symbols includes at least one first symbol: when determining to perform the CG-PUSCH transmission, determine a first set of RBs, wherein the CG-PUSCH transmission occupies the first set of RBs; and when determining to perform the CG-PUSCH transmission, determine, via the UE, a TB to be carried by the CG-PUSCH transmission.

### TECHNICAL FIELD

Embodiments of the present application generally relate to wireless communication technology, especially to a user equipment, a base station and a method for configured grant uplink transmission in wireless network of 3GPP (3rd Generation Partnership Project) 5G New Radio (NR).

### BACKGROUND

For wireless network of 3rd Generation Partnership Project (3GPP) 5G New Radio (NR), technology of time division duplexing (TDD) is widely used. When TDD is operated in a wireless network, only one transmission direction (e.g., downlink (DL) transmission direction or uplink (UL) transmission direction) is supported in a time duration (e.g., a set of symbols). However, allocation of a limited time duration for the UL transmissions can result in reduced coverage and increased latency. Therefore, technology of simultaneous existence of DL transmissions and UL transmissions in a given time duration is introduced (i.e., technology of full duplex is introduced). In some implementations, subband non-overlapping full duplex (SBFD) mode can be introduced in a wireless network, which means the wireless network can support simultaneous UL transmissions and DL transmissions occupying the non-overlapping subbands (e.g., UL transmissions occupies UL subband(s) and DL transmissions occupies DL subband(s)).

In the wireless network, subband non-overlapping full duplex mode may be operated during a time duration (e.g., a set of symbols namely SBFD symbols) while conventional TDD mode may be operated during another time duration (e.g., a set of symbols namely pure UL symbols). UL transmissions should be performed within the UL subband(s) during the SBFD symbols, so allocating frequency domain resource properly for UL transmissions to ensure that is necessary. However, it is not always feasible when the UL transmissions are configured grant (CG) physical uplink shared channel (PUSCH) transmissions. When the allocated frequency domain resource of a CG-PUSCH transmission overlaps with at least one UL subband and at least one DL subband during SBFD symbols, the CG-PUSCH transmission cannot be performed, and this issue need to be solved.

### SUMMARY

Some embodiments of the present application provide a user equipment (UE). The UE includes a processor and a transceiver coupled to the processor. The processor is configured to: receive, via the transceiver, a configured grant (CG) configuration from a base station (BS); determine whether to perform a CG-physical uplink shared channel (CG-PUSCH) transmission in a first set of symbols corresponding to the CG configuration, wherein the first set of symbols includes at least one first symbol; when determining to perform the CG-PUSCH transmission, determine a first set of resource blocks (RBs), wherein the CG-PUSCH transmission occupies the first set of RBs; and when determining to perform the CG-PUSCH transmission, determine a transport block (TB) to be carried by the CG-PUSCH transmission.

Some embodiments of the present application provide a BS. The BS includes a processor and a transceiver coupled to the processor. The processor is configured to: transmit, via the transceiver, a CG configuration to a UE, wherein the CG configuration corresponds to a CG-PUSCH) transmission in a first set of symbols; wherein an indicator in the CG configuration is used for the UE to determine whether to perform the CG-PUSCH transmission in the first set of symbols.

Some embodiments of the present application provide a method for a UE. The method includes: receiving, via the UE, a CG configuration from a BS; determining, via the UE, whether to perform a CG-PUSCH transmission in a first set of symbols corresponding to the CG configuration, wherein the first set of symbols includes at least one first symbol; when determining to perform the CG-PUSCH transmission, determining a first set of RBs, wherein the CG-PUSCH transmission occupies the first set of RBs; and when determining to perform the CG-PUSCH transmission, determining, via the UE, a TB to be carried by the CG-PUSCH transmission.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 is a schematic diagram of resource allocation in accordance with some embodiments of the present application.

FIG. 3 illustrates a schematic diagram of message transmission in accordance with some embodiments of the present application.

FIG. 4A is a schematic diagram of resource allocation in accordance with some embodiments of the present application.

FIG. 4B is a schematic diagram of resource allocation in accordance with some embodiments of the present application.

FIG. 5 is a schematic diagram of resource allocation in accordance with some embodiments of the present application.

FIG. 6 is a schematic diagram of resource allocation in accordance with some embodiments of the present application.

FIG. 7 illustrates a flow chart of a method for wireless communications according to an embodiment of the present disclosure.

FIG. 8 illustrates a block diagram of an exemplary apparatus in accordance with some embodiments of the present application.

### DETAILED DESCRIPTION

The detailed description set forth below in connection with the included tables and appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Reference will now be made in detail to some embodiments of the present application, examples of which are illustrated in the accompanying drawings. Embodiments of the present application may be provided in a network architecture that adopts various service scenarios, for example but is not limited to, 3rd Generation Partnership Project (3GPP) 3G, long-term evolution (LTE), LTE-Advanced (LTE-A), 3GPP 4G, 3GPP 5G New Radio (NR), etc. It is contemplated that along with the 3GPP and related communication technology development, the terminologies recited in the present application may change, which should not affect the principle of the present application.

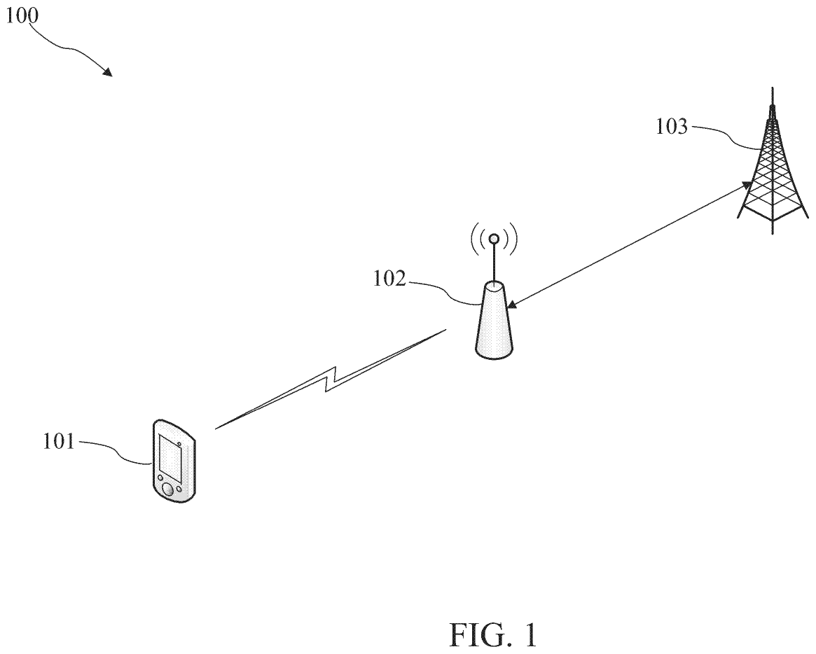

Referring to FIG. 1, a wireless communication system 100 may include a user equipment (UE) 101, a base station (BS) 102 and a core network (CN) 103. Although a specific number of the UE 101, the BS 102 and the CN 103 are depicted in FIG. 1, it is contemplated that any number of the UEs 101, the BSs 102 and the CNs 103 may be included in the wireless communication system 100.

The CN 103 may include a core Access and Mobility management Function (AMF) entity. The BS 102, which may communicate with the CN 103, may operate or work under the control of the AMF entity. The CN 103 may further include a User Plane Function (UPF) entity, which communicatively coupled with the AMF entity.

The BS 102 may be distributed over a geographic region. In certain embodiments of the present application, the BS 102 may also be referred to as an access point, an access terminal, a base, a base unit, a macro cell, a Node-B, an evolved Node-B (eNB), a next generation Node-B (gNB), a Home Node-B, a relay node, or a device, or described using other terminology used in the art. The BS 102 is generally part of a radio access network that may include one or more controllers communicably coupled to one or more corresponding BS(s).

The UE 101 may include, for example, but is not limited to, computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), Internet of Thing (IoT) devices, or the like.

According to some embodiments of the present application, the UE 101 may include, for example, but is not limited to, a portable wireless communication device, a smart phone, a cellular telephone, a flip phone, a device having a subscriber identity module, a personal computer, a selective call receiver, a wireless sensor, a monitoring device, or any other device that is capable of sending and receiving communication signals on a wireless network.

In some embodiments of the present application, the UE 101 may include, for example, but is not limited to, wearable devices, such as smart watches, fitness bands, optical head-mounted displays, or the like. Moreover, the UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE 101 may communicate directly with the BS 102 via uplink communication signals.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol or the 5G NR-light of the 3GPP protocol, wherein the BS 102 transmits data using an OFDM modulation scheme on the downlink (DL) and the UE 101 transmits data on the uplink (UL) using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, the UE 101 and BS 102 may communicate using other communication protocols, such as the IEEE 802.11 family of wireless communication protocols. Further, in some embodiments of the present application, the UE 101 and BS 102 may communicate over licensed spectrums, whereas in other embodiments, the UE 101 and BS 102 may communicate over unlicensed spectrums. The present application is not intended to be limited to the implementation of any particular wireless communication system architecture or protocol. In yet some embodiments of present application, the BS 102 may communicate with the UE 101 using the 3GPP 5G protocols.

In some embodiments of the present application, information exchanged between the BS 102 and the UE 101 in the wireless communications system 100 may include UL transmissions from the UE 101 to the BS 102, or DL transmissions from the BS 102 to the UE 101 over one or more carriers. A carrier may be a portion of a radio frequency spectrum band and may be associated with a particular bandwidth (e.g., 20 megahertz (MHz)). A carrier may be made up of multiple subcarriers and a resource block (RB) is defined as 12 consecutive subcarriers. In some examples, there may be multiple subbands within a carrier and each subband may include a number of consecutive RBs. The time intervals for the wireless communications system 100 may be expressed in multiples of a basic time unit and may be organized according to radio frames each having a specified duration (e.g., 10 milliseconds (ms)). In some examples, a radio frame may be divided into subframes, and each subframe may be further divided into a number of slots. Alternatively, each radio frame may include a variable number of slots and each slot includes a number of symbols (e.g., 14 symbols).

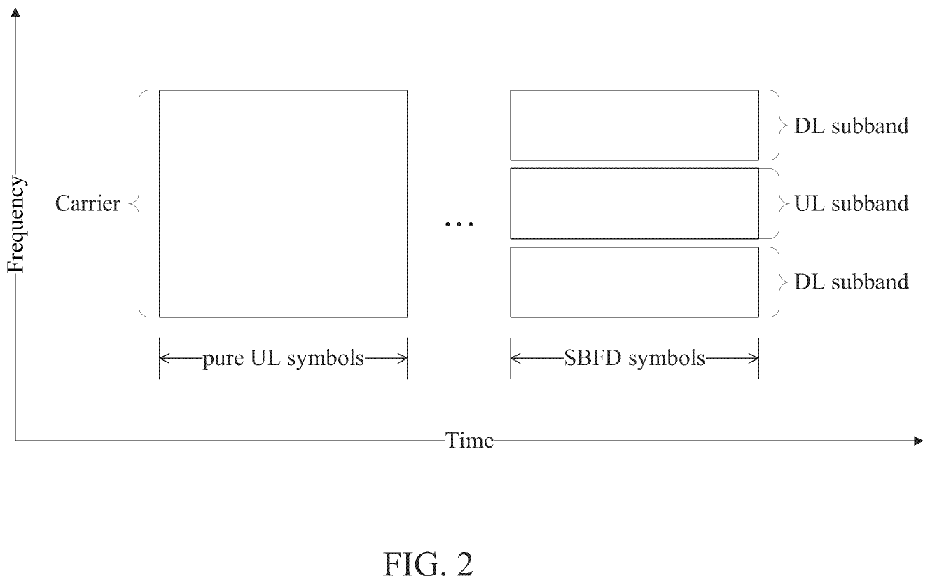

FIG. 2 is a schematic diagram of resource allocation in accordance with some embodiments of the present application. In some embodiments of the present disclosure, regarding the wireless communications system 100, for a carrier, a subband non-overlapping full duplex (SBFD) mode is supported for enhanced coverage, reduced latency, improved system capacity, and improved configuration flexibility. More specifically, under the operation of SBFD mode, there may be simultaneous UL transmission(s) and DL transmission(s), and the UL transmission(s) and the DL transmission(s) are transmitted within non-overlapping subbands (e.g., UL subband and DL subband). SBFD mode may be operated during a set of symbols namely SBFD symbols while conventional TDD mode may be operated during another set of symbols namely pure UL symbols.

The UL and DL transmissions may include physical channel transmissions and physical signal transmissions. A physical channel transmission or a physical signal transmission is transmitted on a set of basic time-frequency domain resources having a defined physical layer structure. Each basic time-frequency domain resource may be referred to as a resource element (RE) which may consist of one symbol in the time domain and one subcarrier in the frequency domain. A set of REs corresponding to a physical channel transmission or a physical signal transmission may span a number of symbols in the time domain and a number of subcarriers within one or more subbands in the frequency domain, that is, the physical channel transmission or the physical signal transmission may be transmitted in a number of symbols and on a number of subcarriers within one or more subbands. In other words, the physical channel transmission or the physical signal transmission may occupy a number of symbols and a number of subcarriers within one or more subbands.

In some embodiments of the present disclosure, for the wireless communications system 100, the UEs 101 may receive a higher layer signaling including a configured grant (CG) configuration indicating a set of RBs corresponding to a CG-physical uplink shared channel (CG-PUSCH) transmission, that is, the UE can perform the CG-PUSCH transmission occupying the set of RBs in frequency domain. For the CG-PUSCH transmission, the UE may further determine a transport block (TB) carried by the CG-PUSCH transmission with a size, which is also referred to as TB size. In the context of the present disclosure, for the UE 101, transmitting a UL transmission may also be referred to as performing a UL transmission or the like, and receiving a DL transmission may also be referred to as performing a DL reception or the like; for the BS 102, transmitting a DL transmission may also be referred to as performing a DL transmission or the like, and receiving a UL transmission may also be referred to as performing a UL reception or the like.

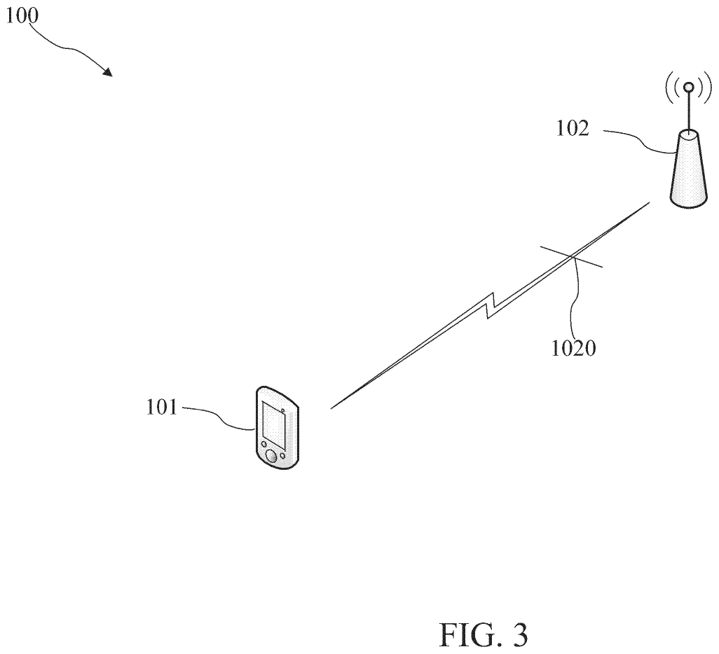

FIG. 3 is a schematic diagram of message transmission in accordance with some embodiments of the present application. In the present disclosure, the BS 102 transmits a higher layer signaling 1020 to the UE 101. The higher layer signaling 1020 includes a CG configuration. The UE 101 receives the higher layer signaling 1020 including the CG configuration from the BS 102. The UE 101 may determine whether to perform a CG-PUSCH transmission during a set of symbols, which includes at least one SBFD symbol, corresponding to the CG configuration.

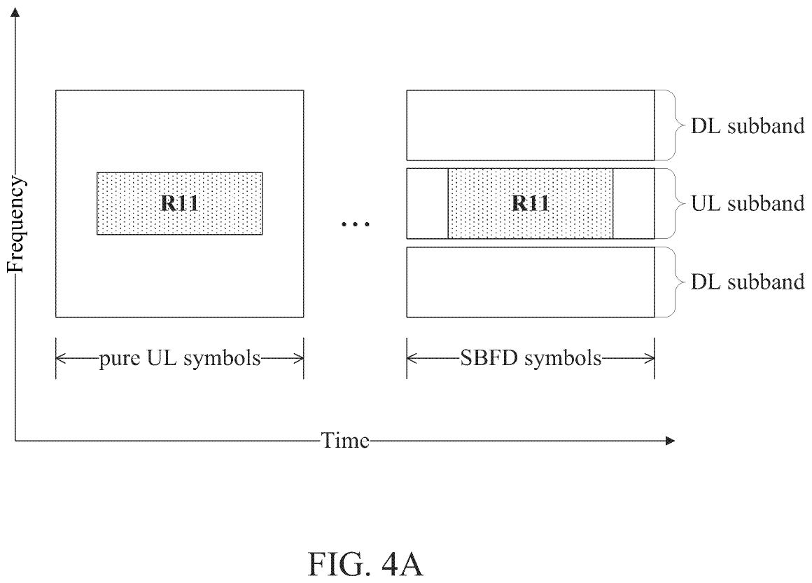

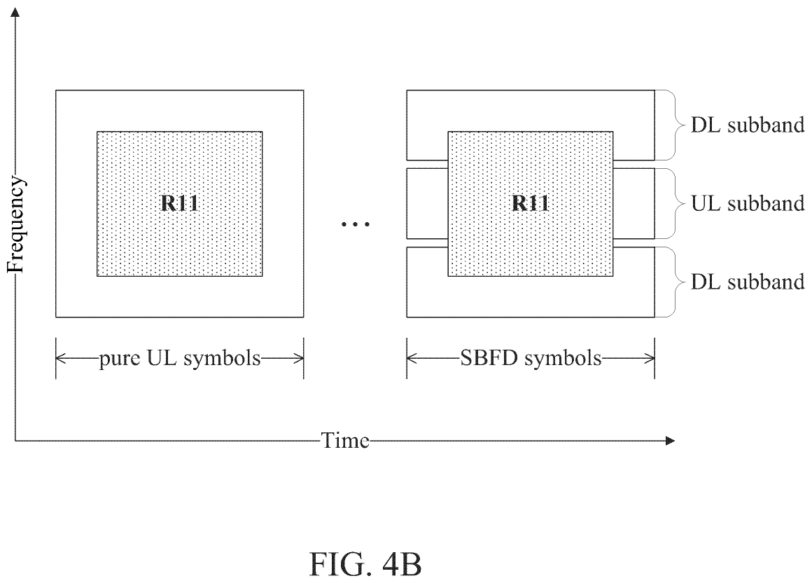

FIGS. 4A to 4B are schematic diagrams of resource allocation in accordance with some embodiments of the present application. In some embodiments, the CG configuration indicates only a set of RBs R11.

As shown in FIG. 4A, in some cases, when the UE 101 determines that the set of RBs R11 is within UL subband(s) when operating SBFD mode according to the CG configuration, the UE 101 then determines to perform the CG-PUSCH transmission in the set of symbols including at least one SBFD symbol.

As shown in FIG. 4B, in some cases, when the UE 101 determines that: (1) the set of RBs R11 overlaps DL subband(s) when operating SBFD mode according to the CG configuration; and (2) a priority class corresponding to the CG-PUSCH transmission is equal to or higher than a priority class threshold (which may be configured in the CG configuration), the UE 101 then determines to perform the CG-PUSCH transmission in the set of symbols including at least one SBFD symbol. In some cases, when the UE 101 determines that: (1) the set of RBs R11 overlaps DL subband(s) when operating SBFD mode; and (2) an indicator in the CG-configuration is set to a first value (e.g., an enabling value ‘1’), the UE 101 then determines to perform the CG-PUSCH transmission in the set of symbols including at least one SBFD symbol.

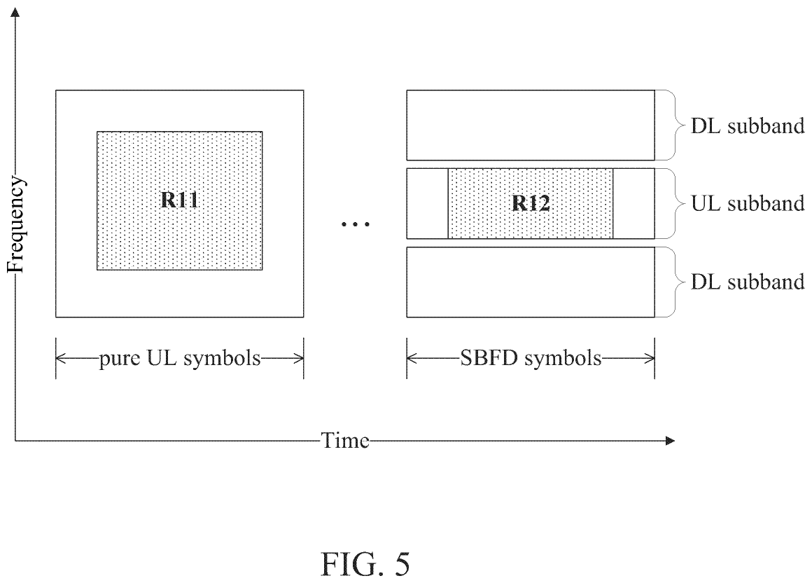

FIG. 5 is a schematic diagram of message transmission in accordance with some embodiments of the present application. In some embodiments, when the UE 101 determines to perform the CG-PUSCH transmission when SBFD mode is operated, that is, the UE 101 performs the CG-PUSCH transmission in the set of symbols including at least one SBFD symbol, the UE 101 further determines a set of RBs R12 corresponds to the SBFD mode. More specifically, the set of RBs R12 is included in the set of RBs R11 and within the UL subband when SBFD mode is operated. The UE 101 determines that the set of RBs R12 can be used for the CG-PUSCH transmission in the set of symbols including at least one SBFD symbol, and whether some conditions associated with the CG-PUSCH transmission are fulfilled. If the conditions are fulfilled, the UE 101 determines a TB to be carried by the CG-PUSCH transmission. If the conditions are not fulfilled, the UE 101 determines not to transmit the CG-PUSCH transmission.

In some cases, the UE 101 calculates a percentage of the set of RBs R12 over the set of RBs R11. When the calculated percentage is greater than a percentage threshold (which may be configured in the CG configuration), the UE 101 determines the TB based on the set of RBs R12. Then, the UE 101 transmits the CG-PUSCH transmission carrying the TB occupying the set of RBs R12 within UL subband(s) in the set of symbols including at least one SBFD symbol.

In some cases, the UE 101 calculates a percentage of the set of RBs R12 over the set of RBs R11. The UE 101 further calculates an actual code rate corresponding to the set of RBs R12. When the calculated percentage is greater than a percentage threshold (which may be configured in the CG configuration) and the actual code rate is less than a code rate threshold (which may be configured in the CG configuration), the UE 101 determined the TB based on the set of RBs R11. Then, the UE 101 transmits the CG-PUSCH transmission carrying the TB occupying the set of RBs R12 within UL subband(s) in the set of symbols including at least one SBFD symbol.

In some cases, the UE 101 calculates a percentage of the set of RBs R12 over the set of RBs R11. When the calculated percentage is greater than a percentage threshold (which may be configured in the CG configuration) and the CG-PUSCH transmission is a code block group (CBG) based transmission, the UE 101 determines the TB based on the set of RBs R11. Then, the UE 101 transmits the CG-PUSCH transmission carrying at least one CBG of the TB occupying the set of RBs R12 within UL subband(s) in the set of symbols including at least one SBFD symbol.

In some embodiments, the CG-PUSCH transmission is one of a plurality of CG-PUSCH repetition transmissions. For each CG-PUSCH repetition transmission which is going to be performed in the set of symbols including at least one SBFD symbol, the UE 101 calculates a percentage of a set of RBs corresponding to SBFD mode over the set of RBs R11. The set of RBs corresponding to SBFD mode is determined by which RBs included in the set of RBs R11 are within the UL subband when SBFD mode is operated. In these embodiments, the UE 101 determines the percentage of the set of RBs R12 over the set of RBs R11 is minimum among the calculated percentages.

In some cases, when the minimum percentage is greater than a percentage threshold (which may be configured in the CG configuration), the UE 101 determines the TB based on the set of RBs R12. Then, for the CG-PUSCH repetition transmission(s) which is (are) going to be performed in the set of symbols including at least one SBFD symbol, the UE 101 transmits the CG-PUSCH repetition transmission(s) carrying the TB occupying the set of RBs corresponding to SBFD mode. For the CG-PUSCH repetition transmission(s) which is (are) going to be performed in the pure UL symbols, the UE 101 transmits the CG-PUSCH repetition transmission(s) carrying the TB occupying the set of RBs R11.

In some cases, when the minimum percentage is greater than a percentage threshold (which may be configured in the CG configuration) and a maximum actual code rate is less than a code rate threshold (which may be configured in the CG configuration), the UE 101 determined the TB based on the set of RBs R11. Then, for the CG-PUSCH repetition transmission(s) which is (are) going to be performed in the set of symbols including at least one SBFD symbol, the UE 101 transmits the CG-PUSCH repetition transmission(s) carrying the TB occupying the set of RBs corresponding to SBFD mode. For the CG-PUSCH repetition transmission(s) which is (are) going to be performed in the pure UL symbols, the UE 101 transmits the CG-PUSCH repetition transmission(s) carrying the TB occupying the set of RBs R11.

In some cases, when the minimum percentage is greater than a percentage threshold (which may be configured in the CG configuration) and the plurality of CG-PUSCH repetition transmissions are CBG based transmission, the UE 101 determines the TB based on the set of RBs R11. Then, for the CG-PUSCH repetition transmission(s) which is (are) going to be performed in the set of symbols including at least one SBFD symbol, the UE 101 transmits the CG-PUSCH repetition transmission(s) carrying at least one CBG of the TB occupying the set of RBs corresponding to SBFD mode. For the CG-PUSCH repetition transmission(s) which is (are) going to be performed in the pure UL symbols, the UE 101 transmits the CG-PUSCH repetition transmission(s) carrying the TB occupying the set of RBs R11.

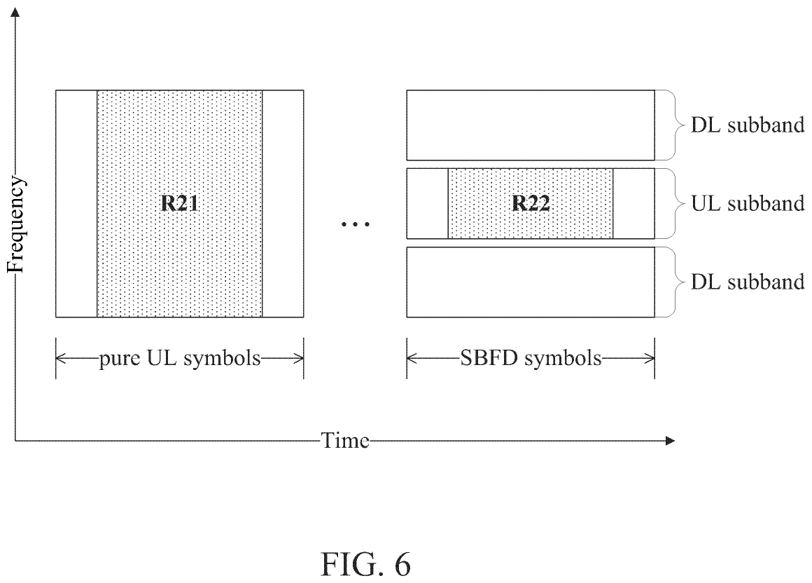

FIG. 6 is a schematic diagram of resource allocation in accordance with some embodiments of the present application. In some embodiments, the CG configuration indicates: (1) a set of RBs R21 corresponding to TDD mode; and (2) a set of RBs R22 corresponding to SBFD mode. Each of the CG-PUSCH repetition transmissions may be performed in pure UL symbols or in a set of symbols including at least one SBFD symbol. The UE 101 calculates the TB based on the set of RBs R21.

In some cases, regarding the CG-PUSCH repetition transmissions which are going to be performed in the pure UL symbols, the CG-PUSCH repetition transmissions: (1) are performed occupying the set of RBs R21; and (2) carries the TB.

In some cases, regarding the CG-PUSCH repetition transmissions which are going to be performed in the set of symbols including at least one SBFD symbol, the CG-PUSCH repetition transmissions: (1) are performed occupying the set of RBs R22; and (2) carries some CBGs of the TB.

It should be noted that, in some embodiments, if the set of RBs 22 overlaps with DL subband(s), the UE 101 is going to perform only the CG-PUSCH repetition transmissions in the pure UL symbols. In other words, the UE 101 is not going to perform the CG-PUSCH repetition transmissions in the set of symbols including at least one SBFD symbol.

In some embodiments, one set of CBGs carried by the CG-PUSCH transmissions (or CG-PUSCH repetition transmissions) occupying the set of RBs corresponding to the SBFD mode may be determined.

In some cases, a first set of CBGs is included in a TB calculated based on the set of RBs corresponding to TDD mode, and consists of ‘N1’ number of CBGs, which are CBG ‘1’, CBG ‘2’, . . . , CBG ‘N1’, and the set of RBs corresponding to TDD mode consists of ‘M1’ number of RBs while the set of RBs corresponding to SBFD mode consists of ‘M2’ number of RBs. In these cases, ‘N2’ number of the CBGs carried by the CG-PUSCH transmissions (or CG-PUSCH repetition transmissions) occupying the set of RBs corresponding to SBFD mode is determined by an expression N2= [N1*M2/M1].

In addition, for which ‘N2’ number of CBGs are determined to be transmitted in the current CG-PUSCH transmission, the ‘N2’ number of CBGs are selected: (1) with smallest N2 indexes (e.g., CBG ‘l’, CBG ‘2’, . . . , CBG ‘N2’) when the CG-PUSCH transmission is not one of a plurality of CG-PUSCH repetition transmissions; or (2) with N2 indexes counted from index of last transmitted CBG when the CG-PUSCH transmission is one of the CG-PUSCH repetition transmissions. Regarding (2), for example, in last CG-PUSCH repetition transmission, CBG ‘1’, CBG ‘2’, . . . , CBG ‘n1’ are transmitted. Therefore, in the current CG-PUSCH repetition transmission, CBG ‘1’, CBG ‘2’, . . . , CBG ‘n2’

$$( n 2 = \frac{n 1}{2} in this example )$$

are transmitted, and in next CG-PUSCH repetition transmission, CBG ‘n2+1’, CBG ‘n2+2’, . . . , CBG ‘n1’ are transmitted.

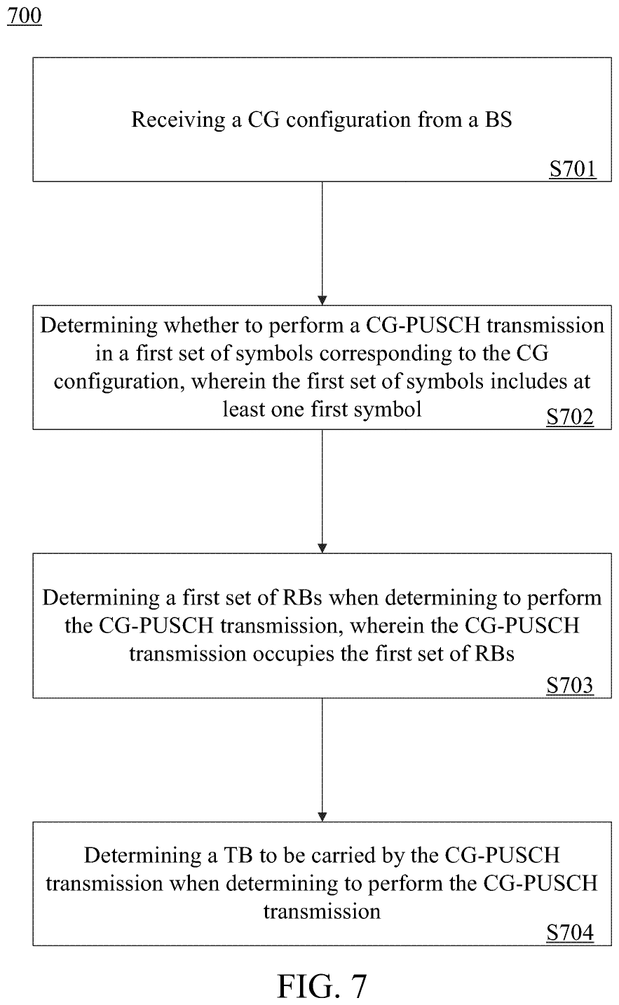

FIG. 7 illustrates a flow chart of a method for wireless communications in accordance with some embodiments of the present application. Referring to FIG. 7, method 700 is performed by a UE in some embodiments of the present application.

In some embodiments, operation S701 is executed to receive, via the UE, a CG configuration from a BS. Operation S702 is executed to determine, via the UE, whether to perform a CG-PUSCH transmission in a first set of symbols corresponding to the CG configuration. The first set of symbols includes at least one first symbol, that is, SBFD symbol. Operation S703 is executed to determine, via the UE, a first set of RBs (e.g., set of RBs 12 or set of RBs 22 in the previous embodiments) when determining to perform the CG-PUSCH transmission. The CG-PUSCH transmission occupies the first set of RBs. Operation S704 is executed to determine, via the UE, a TB to be carried by the CG-PUSCH transmission when determining to perform the CG-PUSCH transmission.

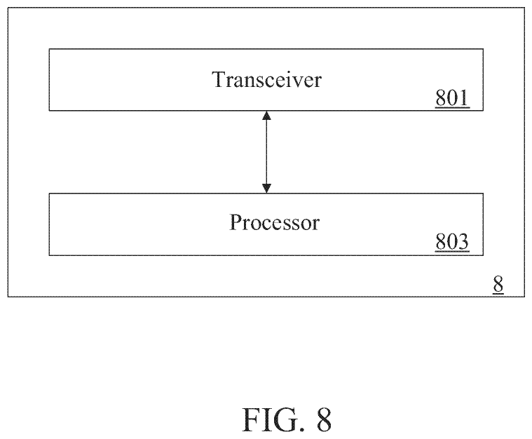

FIG. 8 illustrates an example block diagram of an apparatus 8 according to an embodiment of the present disclosure.

As shown in FIG. 8, the apparatus 8 may include at least one non-transitory computer-readable medium (not illustrated in FIG. 8), a transceiver 801 and a processor 803 electrically coupled to the non-transitory computer-readable medium (not illustrated in FIG. 8) and the transceiver 801. The apparatus 8 may be a UE or a BS.

Although in this figure, elements such as transceiver 801 and processor 803 are described in the singular, the plural is contemplated unless limitation to the singular is explicitly stated. In some embodiments of the present disclosure, the transceiver 801 may be separated into to circuitry, such as a receiving circuitry and a transmitting circuitry. In certain embodiments of the present disclosure, the apparatus 8 may further include an input device, a memory, and/or other components.

In some embodiments of the present disclosure, the non-transitory computer-readable medium may have stored thereon computer-executable instructions to cause a processor to implement the method with respect to the user equipment as described above. For example, the computer-executable instructions, when executed, cause the processor 803 interacting with the transceiver 801, so as to perform the operations with respect to the UE depicted in the figures.

Those having ordinary skill in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including”.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE), comprising:
at least one memory; and
at least one processor coupled with the at least one memory and configured to cause the UE to:
receive a configured grant (CG) configuration from a base station;
determine whether to perform a CG-physical uplink shared channel (CG-PUSCH) transmission in a first set of symbols corresponding to the CG configuration, wherein the first set of symbols includes at least one first symbol;
when determining to perform the CG-PUSCH transmission, determine a first set of resource blocks (RBs), wherein the CG-PUSCH transmission occupies the first set of RBs; and
when determining to perform the CG-PUSCH transmission, determine a transport block (TB) to be carried by the CG-PUSCH transmission.

2. The UE of claim 1, wherein the at least one processor is configured to cause the UE to:
determine the first set of RBs when the CG configuration indicates at least the first set of RBs and a second set of RBs, wherein the first set of RBs corresponds to subband non-overlapping full duplex (SBFD) mode.

3. The UE of claim 1, wherein the at least one processor is configured to cause the UE to:
determine the first set of RBs when the CG configuration indicates only a second set of RBs, wherein the first set of RBs is included in the second set of RBs and corresponds to SBFD mode.

4. The UE of claim 3, wherein the at least one processor is configured to cause the UE to:
determine to perform the CG-PUSCH transmission in the first set of symbols corresponding to the CG configuration when the second set of RBs is within one or more UL subbands.

5. The UE of claim 3, wherein the at least one processor is configured to cause the UE to:
determine to perform the CG-PUSCH transmission in the first set of symbols corresponding to the CG configuration when the second set of RBs overlaps at least one downlink (DL) subband and a priority class corresponding to the CG-PUSCH transmission is equal to or higher than a priority class threshold.

6. The UE of claim 3, wherein the at least one processor is configured to cause the UE to:
determine to perform the CG-PUSCH transmission in the first set of symbols corresponding to the CG configuration when an indicator in the CG configuration is set to a first value.

7. The UE of claim 3, wherein the at least one processor is configured to cause the UE to:
determine the TB based on the first set of RBs; and
transmit the CG-PUSCH transmission carrying the TB.

8. The UE of claim 3, wherein the at least one processor is configured to cause the UE to:
determine the TB based on the second set of RBs; and
transmit the CG-PUSCH transmission carrying the TB.

9. The UE of claim 3, wherein the at least one processor is configured to cause the UE to:
determine the TB based on the second set of RBs; and
transmit the CG-PUSCH transmission carrying at least one CBG of the TB.

10. The UE of claim 1, wherein the CG-PUSCH transmission is one CG-PUSCH transmission of a plurality of CG-PUSCH repetition transmissions.

11. The UE of claim 2, wherein the CG-PUSCH transmission is code block group (CBG) based, and the at least one processor is configured to cause the UE to:
determine number of at least one CBG by
$$N = ⌊ n \times \frac{M 2}{M 1} ⌋ ,$$
while N is the number of the at least one of CBG, n is number of total CBGs included in the TB, M2 is number of RBs included in the first set of RBs within one or more UL subband and M1 is number of RBs included in the second set of RBs; and
transmit the CG-PUSCH transmission carrying the at least one CBG of the TB.

12. The UE of claim 2, wherein the at least one processor is configured to cause the UE to:
select N number of CBGs with smallest N indexes when the CG-PUSCH transmission is not one of CG-PUSCH repetition transmissions; or
select N number of CBGs with N indexes counted from index of last transmitted CBG when the CG-PUSCH transmission is one of the CG-PUSCH repetition transmissions.

13. A base station, comprising:
at least one memory; and
at least one processor coupled with the at least one memory and configured to cause the base station to:
transmit a configured grant (CG) configuration to a user equipment (UE), wherein the CG configuration corresponds to a CG-physical uplink shared channel (CG-PUSCH) transmission in a first set of symbols;
wherein an indicator in the CG configuration is used for the UE to determine whether to perform the CG-PUSCH transmission in the first set of symbols.

14. A method performed by a user equipment (UE), the method comprising:
receiving a configured grant (CG) configuration from a base station;
determining whether to perform a CG-physical uplink shared channel (CG-PUSCH) transmission in a first set of symbols corresponding to the CG configuration, wherein the first set of symbols includes at least one first symbol;
when determining to perform the CG-PUSCH transmission, determining a first set of resource blocks (RBs), wherein the CG-PUSCH transmission occupies the first set of RBs; and
when determining to perform the CG-PUSCH transmission, determining a transport block (TB) to be carried by the CG-PUSCH transmission.

15. A processor for wireless communication, comprising:
at least one controller coupled with at least one memory and configured to cause the processor to:
receive a configured grant (CG) configuration from a base station;
determine whether to perform a CG-physical uplink shared channel (CG-PUSCH) transmission in a first set of symbols corresponding to the CG configuration, wherein the first set of symbols includes at least one first symbol;
when determining to perform the CG-PUSCH transmission, determine a first set of resource blocks (RBs), wherein the CG-PUSCH transmission occupies the first set of RBs; and
when determining to perform the CG-PUSCH transmission, determine a transport block (TB) to be carried by the CG-PUSCH transmission.

16. The processor of claim 15, wherein the at least one controller is configured to cause the processor to:
determine the first set of RBs when the CG configuration indicates at least the first set of RBs and a second set of RBs, wherein the first set of RBs corresponds to subband non-overlapping full duplex (SBFD) mode.

17. The processor of claim 15, wherein the at least one controller is configured to cause the processor to:
determine the first set of RBs when the CG configuration indicates only a second set of RBs, wherein the first set of RBs is included in the second set of RBs and corresponds to SBFD mode.

18. The processor of claim 17, wherein the at least one controller is configured to cause the processor to:
determine to perform the CG-PUSCH transmission in the first set of symbols corresponding to the CG configuration when the second set of RBs is within one or more UL subbands.

19. The processor of claim 17, wherein the at least one controller is configured to cause the processor to:
determine to perform the CG-PUSCH transmission in the first set of symbols corresponding to the CG configuration when the second set of RBs overlaps at least one downlink (DL) subband and a priority class corresponding to the CG-PUSCH transmission is equal to or higher than a priority class threshold.

20. The processor of claim 17, wherein the at least one controller is configured to cause the processor to:
determine to perform the CG-PUSCH transmission in the first set of symbols corresponding to the CG configuration when an indicator in the CG configuration is set to a first value.
